(19) United States
(12) Patent Application Publication
(10) Pub. No.: US 2017/0027102 A1
(43) Pub. Date: Feb. 2, 2017

(54) SEED SAMPLING SYSTEM AND METHOD

(71) Applicant: DOW AGROSCIENCES LLC, Indianapolis, IN (US)

(72) Inventors: Eric FREDERICKSEN, Indianapolis, IN (US); Pradeep SETLUR, Indianapolis, IN (US); Max O. RUEGGAR, Indianapolis, IN (US); Oswald R. CRASTA, Carmel, IN (US); Raghav RAM, Carmel, IN (US); Pradeep R. MARRI, Carmel, IN (US); Naveen PARTHASARTHY, Indianapolis, IN (US); Lasantha UBAYASENA, West Lafayette, IN (US); Tyler Buit, Carmel, IN (US); Brandon S. RAPIER, Westfield, IN (US)

(21) Appl. No.: 15/223,370

(22) Filed: Jul. 29, 2016

Related U.S. Application Data
(60) Provisional application No. 62/199,468, filed on Jul. 31, 2015.

(51) Int. Cl. A01C 1/00; C12Q 1/68; B26D 1/00; B26D 7/01; B26D 7/06

(52) U.S. Cl. CPC A01C 1/00; B26D 7/01; B26D 7/0641; B26D 1/0006; C12Q 1/6806; B26D 2007/0025

(57) ABSTRACT

A method system/apparatus for the streamlined cutting of seeds to sample the seeds and select seeds for planting is disclosed. A method of sampling seeds using such system/apparatus is also provided. The seeds are manually positioned and cut by a serrated cutting tool.

### CROSS REFERENCE TO RELATED APPLICATIONS

This application claims priority to U.S. Provisional Application Ser. No. 62/199,468, which was filed on Jul. 31, 2015 and is expressly incorporated herein by reference.

### TECHNICAL FIELD

The present disclosure relates generally to devices for obtaining samples from seeds for various testing, including for example genetic testing or testing of oil content/composition.

### BACKGROUND

Field genotyping efforts known in the art involve manual leaf sampling to genotype plant populations. These efforts require considerable resources as seeds must be processed, sorted, and planted. Resulting plants must be maintained to produce seedlings before genetic sampling can occur. The vast majority of these seedlings would be undesirable and must be discarded and destroyed. Therefore, manual leaf sampling results in the inefficient usage of field resources and expenditure of employee time. An improved, streamlined genotyping process that reduces the number of seedlings grown and frees a considerable amount of field station resources may accelerate future production and development of plant populations. Novel processes that can be used to identify which seeds to plant would be desirable. An efficient and high-throughput method for genotyping plant seeds while maintaining seed viability would facilitate breeding programs and have the potential to increase crop productivity.

### SUMMARY

A method and apparatus for streamlined manual seed sampling is disclosed. According to one aspect, a seed cutting system/apparatus is disclosed. The seed cutting system/apparatus comprises a cutting device operable to remove material from a seed. The seed cutting system/apparatus includes a seed guide that includes an opening sized to receive material removed from the seed. A cleaning system/module operable to clean the seed guide is also included in the seed cutting apparatus. The apparatus provided may include a collection tray configured to receive material removed from the seed. The seed guide is moveable between a first position and a second position. In the first position, the seed guide is positioned between the cutting device and the collection tray, and the seed guide directs material removed from the seed to the collection tray. In the second position, the opening of the seed guide is positioned below a nozzle of the cleaning system.

The scope of the disclosure is not limited to the specified structures or the specific terms used. For example, the term “nozzle” may be substituted with the term “pressure source.” Additionally, the term “seed guide” may be substituted for the term “funnel,” and the term “cutting device” may be substituted with the terms “rotating blade” or “saw.”

In some embodiments, the cutting device may include a body configured to rotate about a central axis. The body may include a serrated section extending circumferentially from a first end to a second end. The serrated section may have a plurality of cutting teeth that define a first radius of the body at the first end and a second radius of the body at the second end. The second radius may be greater than the first radius.

In some embodiments, the seed guide may include a funnel that is movable between the first position and the second position.

In some embodiments, the funnel may include an upper funnel and a lower funnel positioned below the upper funnel. The lower funnel may be operable to be moved between a raised position and a lowered position.

In some embodiments, the seed cutting apparatus may further comprise a protective barrier positioned between the cutting device and the collection tray. The lower funnel may extend through the protective barrier when in the lowered position.

In some embodiments, the cleaning system may be operable to clean the funnel when the funnel is in the second position.

In some embodiments, the cleaning system may include a compressed air source.

In some embodiments, the seed cutting apparatus may further comprise a second collection tray configured to receive the seed.

In some embodiments, the seed cutting apparatus may further comprise a sensor configured to detect when the seed is deposited in the collection tray.

In some embodiments, the seed cutting apparatus may further comprise an indexing system.

In some embodiments, the seed cutting apparatus may further comprise a lever assembly operable to advance the seed toward the cutting device.

In some embodiments, the seed cutting apparatus may further comprise an activation switch to energize the cutting device. The lever assembly may be configured to engage the activation switch.

In some embodiments, the seed cutting apparatus may further comprise a seed carrier removeably coupled to the lever assembly. The seed carrier may include a groove sized to receive the seed.

In some embodiments, the seed carrier may include a plurality of seed carriers. Each seed carrier may be configured to receive a different seed type. In some embodiments, the seed cutting apparatus the seed type may be a corn seed, a cotton seed, a sunflower seed, a wheat seed, a rice seed, a canola seed, a sorghum seed, or a soybean seed.

In some embodiments, the seed cutting apparatus of may further comprise a spring to provide compliance between the seed carrier and the lever assembly.

In some embodiments, the groove may be V-shaped. The angle of the groove may be an acute angle of less than about 90°. In some embodiments, the angle may be from about 1° to about 89°, from about 1° to about 45°, or from about 45° to about 89°. Illustratively, the groove may be U-shaped.

In some embodiments, the seed cutting apparatus may further comprise a negative pressure source configured to be coupled to the seed carrier.

In some embodiments, the seed cutting apparatus may further comprise a linear actuator operable to move the seed guide between the first position and the second position.

In some embodiments, the seed cutting apparatus may further comprise a hotel configured to receive a plurality of collection trays.

In some embodiments, the seed cutting apparatus may further comprise a second cleaning device configured to clean the cutting device.

In further embodiments, a cutting tool is disclosed. The cutting tool comprises a body configured to rotate about a central axis. The body includes a serrated section extending circumferentially from a first end to a second end. The serrated section has a plurality of cutting teeth that define a first radius of the body at the first end and a second radius of the body at the second end. The second radius is greater than the first radius.

In some embodiments, the plurality of cutting teeth may define a gradually increasing radius from the first end to the second end.

In some embodiments, the serrated section may be a first serrated section, and the plurality of cutting teeth may be a first plurality of cutting teeth. In some embodiments, a large number of equally spaced teeth may be employed to produce finer cuts. Conversely, in some embodiments, a smaller number of equally spaced teeth may be employed to produce coarser cuts. The blade used may comprise a number of teeth between 100 and 300. In one embodiment, the blade used has 128 teeth at 3 mm pitch. Additionally, the size and pitch of the teeth may be configured to optimally remove a sample from any given species of seed. The pitch of teeth may be between 1.5 mm and 4.5 mm; between 2.2 mm and 3 mm; or between 2.5 mm and 3.5 mm. The body may include a second serrated section that extends circumferentially from a third end adjacent to the second end of the first serrated section to a fourth end. The second serrated section may have a second plurality of cutting teeth that define a third radius of the body at the third end. The third radius may be less than the second radius.

In some embodiments, the second plurality of cutting teeth may define a fourth radius of the body at the fourth end. The fourth radius may be greater than the third radius.

In some embodiments, the third radius may be equal in length to the first radius, and the fourth radius may be equal in length to the second radius.

In some embodiments, the first plurality of cutting teeth may define a gradually increasing radius from the first end to the second end. The second plurality of cutting teeth may define a gradually increasing radius from the third end to the fourth end.

In some embodiments, the second end of the first serrated section and the third end of the second serrated section may be connected by an edge extending in a substantially radial direction.

In some embodiments, the first serrated section may define an arc extending about 90 degrees.

In some embodiments, each cutting tooth of the plurality of cutting teeth may extend radially outward from a base to a tip. A distance between each tip and the central axis may define a radius of the body.

In some embodiments the tips of the teeth may extend away from the second end of the serrated section.

In some embodiments, the body may be configured to rotate in a first direction about the central axis. Each cutting tooth of the plurality of cutting teeth may extend in the first direction from its base to its tip.

In some embodiments, a mounting slot may be defined in the center of the body.

In some embodiments the body may include a plurality of serrated sections. Each serrated section may have a gradually increasing radius.

According to another aspect, a method of cutting a seed is disclosed. The method comprises manually placing a seed on a platform. The method further comprises operating a loader to move the seed along the platform toward a cutting tool. Additionally, the method includes activating the cutting tool to remove a sample from the seed. Furthermore, the method includes obtaining the sample removed from the seed. The method includes removing the cut seed from the loader. The method also includes depositing the cut seed in a slot.

In some embodiments, the method may further comprise activating an indexing device to index the cut seed and the sample to associate the cut seed with the sample.

In some embodiments, the method may further comprise extracting DNA, proteins, fatty acid oils, or other seed parts from the sample. In some embodiments, the method may further comprise removing all or part of the embryo, endosperm, seed coat, or cotyledon from the seed.

In some embodiments, the method may further comprise determining genetic information about the seed from the sample. In other embodiments, the method may further comprise determining fatty acid oil profile information about the seed from the sample. In further embodiments, the method may further comprise determining protein information about the seed from the sample.

In some embodiments, manually placing the seed on the platform may comprise orienting the seed such that an embryo of the seed faces away from the cutting tool.

In some embodiments, manually placing the seed on the platform may comprise positioning the seed in a slot defined in the loader.

In some embodiments, the seed may be cut at a first cutting depth. The cutting depth may gradually increase from the first cutting depth to the second cutting depth when the cutting tool is activated.

In some embodiments, the seed may be a corn seed, a cotton seed, a sunflower seed, a wheat seed, a rice seed, a canola seed, a sorghum seed, or a soybean seed.

In some embodiments, the seed may be a seed obtained from a monocotyledonous plant. In some embodiments, the seed may be a seed obtained from a dicotyledonous plant.

In some embodiments, the method may further comprise planting the seed after the sample is removed from the seed. In some embodiments, the method may further comprise saving the seed after the sample is removed from the seed.

In some embodiments, the method may further comprise extracting DNA from the sample and planting the seed after the sample is removed from the seed. In some embodiments, the method may further comprise extracting protein from the sample and planting the seed after the sample is removed from the seed. In some embodiments, the method may further comprise fatty acid oils from the sample and planting the seed after the sample is removed from the seed.

According to another aspect, a method of cutting a seed is disclosed. The method comprises receiving a seed from a user. The seed is held in position at a cutting device by a loader. The method includes cutting the seed with the cutting device at a first cutting depth and a second cutting depth different than the first cutting depth to produce a sample. Additionally, the method comprises moving a sample guide between a first position and a second position. In the first position, the sample guide is positioned between the cutting device and a collection tray to direct material removed from the seed to the collection tray. In the second position, the opening of the seed guide is positioned below a nozzle of the cleaning system. The seed is detected in a seed tray, and an indexing system is activated. As the seed is cut, the cutting depth gradually increases from the first cutting depth to the second cutting depth when the cutting tool is activated.

### BRIEF DESCRIPTION OF THE DRAWINGS

The detailed description particularly refers to the following figures, in which:

FIG. 1 is a perspective view of one embodiment of a seed cutting system;

FIG. 2 is a simplified block diagram of the seed cutting assembly of FIG. 1;

FIG. 3 is a perspective view of a seed holder assembly of the system of FIG. 1;

FIG. 4 is an exploded perspective view of the seed holder assembly of FIG. 3;

FIG. 5 is a front perspective view of a seed carrier of the holder assembly of FIG. 3;

FIG. 6 is a bottom plan view of the seed carrier of FIG. 5;

FIG. 7 is a top perspective view of the holder assembly of FIG. 3;

FIG. 8 is a perspective view of the holder assembly of FIG. 3 showing the holder assembly in a cutting position;

FIG. 9 is a side elevation view of a cutting blade of the system of FIG. 1;

FIG. 10 is a cutaway side elevation view of a section of the cutting blade of FIG. 9;

FIG. 11 is a perspective view of additional components of the system of FIG. 1;

FIG. 12 is a perspective view of a seed tray of the system of FIG. 1;

FIG. 13 is a perspective view of a sample tray with sample tubes of the system of FIG. 1;

FIG. 14 is a perspective view of a seed guide of the system of FIG. 1;

FIG. 15 is a perspective view of a sample guide mechanism of the system of FIG. 1 in a sampling position;

FIG. 16 is another perspective view of the sample guide mechanism of FIG. 15;

FIG. 17 is another perspective view of the sample guide mechanism of FIG. 15 in a cleaning position;

FIG. 18 is a perspective view of a corn seed;

FIG. 19 is a perspective view of a corn seed after performing a cutting operation with the system of FIG. 1;

FIG. 20 is a plot of seed sample size showing the weight of the sample resulting from each trial;

FIGS. 21A-C show another embodiment of a seed carrier of the system of FIG. 1;

FIGS. 22A-C show yet another embodiment of a seed carrier of the system of FIG. 1; and

FIGS. 23A-C show yet another embodiment of a seed carrier of the system of FIG. 1.

### DETAILED DESCRIPTION OF THE DRAWINGS

While the concepts of the present disclosure are susceptible to various modifications and alternative forms, specific exemplary embodiments thereof have been shown by way of example in the drawings and will herein be described in detail. It should be understood, however, that there is no intent to limit the concepts of the present disclosure to the particular forms disclosed, but on the contrary, the intention is to cover all modifications, equivalents, and alternatives falling within the spirit and scope of the invention as defined by the appended claims.

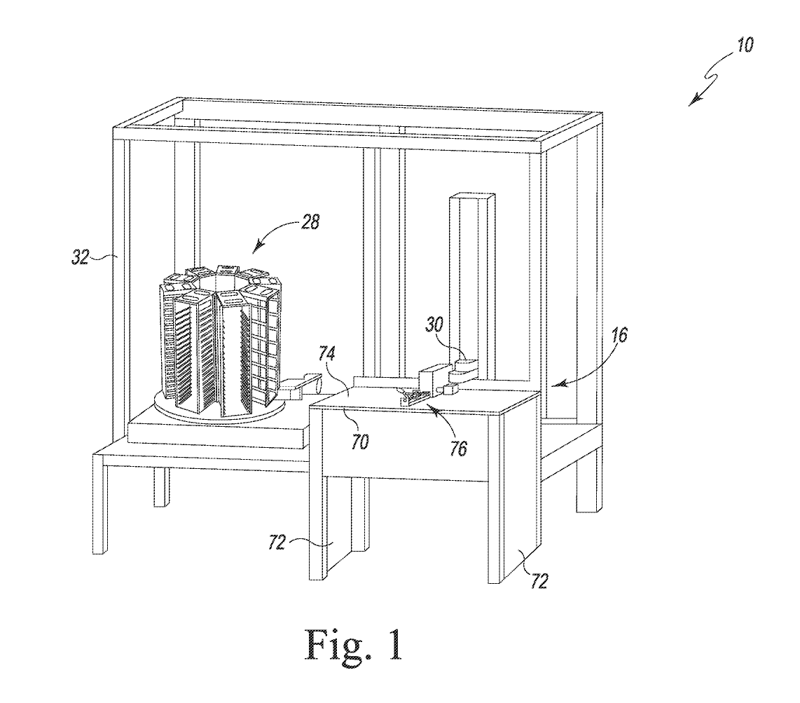

Referring to FIG. 1, a system 10 for removing a sample 12 from a seed 14 for genetic, protein, or fatty acid oil profile testing is shown. The system 10 is illustratively configured to take samples 12 from corn, cotton, or soybean seeds 14 as part of a genotype sampling protocol. It should be appreciated that in some embodiments the system 10 may be configured to take samples 12 from other species of seeds. It should also be appreciated that in some embodiments the system 10 may be configured to take samples 12 from monocotyledonous seeds. It should further be appreciated that in some embodiments the system 10 may be configured to take samples 12 from dicotyledonous seeds. As described in greater detail below, a user manually provides a seed 14 to the system 10 and operates the system 10 to remove a sample 12 from the seed 14 in such a way that seed viability is not compromised. As used herein, “viability” refers to the ability of a seed, including a seed that has been cut by the system 10, to, among other things, germinate. The system 10 is configured to index the sample 12 and the seed 14 from which the sample 12 was taken such that the sample may be tracked during genetic testing. As part of the genetic testing, genetic traits of the sample 12 may be identified to suggest the phenotypic parameters of a plant that would result from the seed 14. As part of the protein testing, genetic traits or post-translational protein modifications of the sample 12 may be identified to suggest the phenotypic parameters of a plant that would result from the seed 14. As part of the fatty acid oil profile testing, the fatty acid content of the sample 12 may be identified to suggest the phenotypic parameters of a plant that would result from the seed 14. If the seed 14 is predicted to produce a plant with desired phenotypic properties, the seed 14 may be identified and saved. Additionally, if the seed 14 is predicted to produce a plant with desired phenotypic properties, the seed 14 may be planted. Conversely, if the seed 14 is predicted to produce a plant without desired phenotypic properties, the planting the seed 14 may be circumvented, thereby saving resources. Advantageously, the system 10 allows plant populations to be genetically sampled while only planting a subset of the population's seeds, thereby saving resources compared to planting all of the population's seeds. In other embodiments, the system 10 allows plant populations to be sampled for protein composition while only planting a subset of the population's seeds, thereby saving resources compared to planting all of the population's seeds. In further embodiments, the system 10 allows plant populations to be sampled for fatty acid oil composition while only planting a subset of the population's seeds, thereby saving resources compared to planting all of the population's seeds.

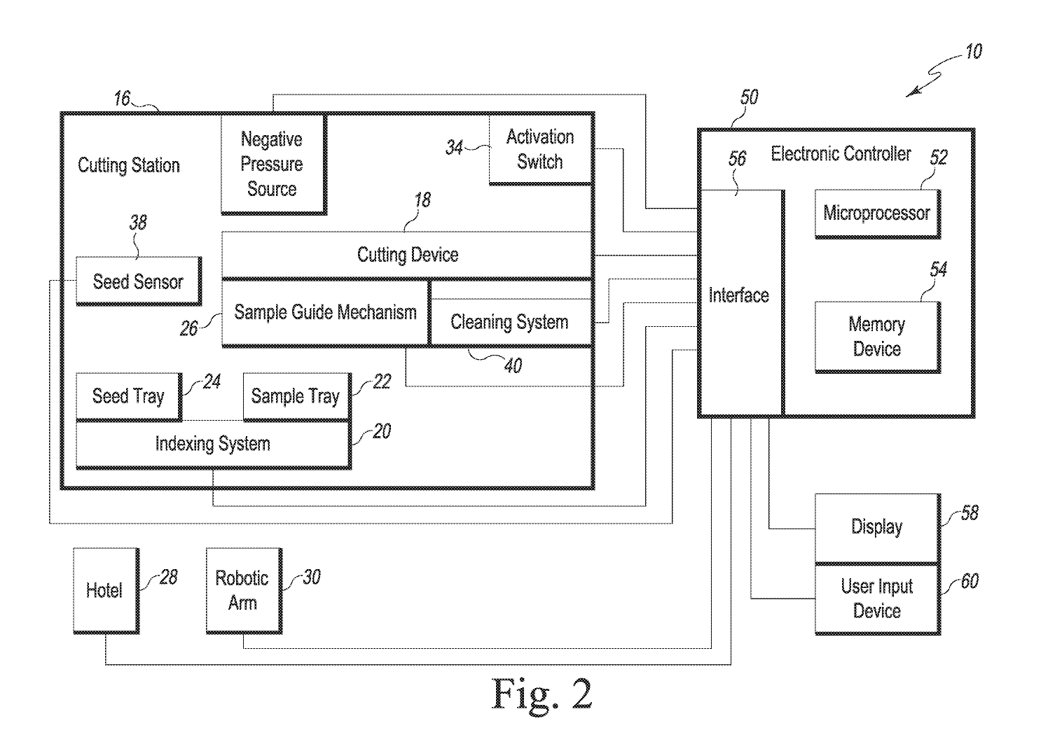

As shown in FIG. 2, the system 10 includes a seed cutting station 16 that includes a seed cutting device 18 and an indexing system 20 that supports a sample tray 22 and a seed tray 24. The system 10 also includes a hotel 28 for storing the sample trays 22 and the seed trays 24 and a robotic arm 30 for moving the trays 22, 24 from the cutting station 16 to a hotel 28. One exemplary hotel 28 is the Cytomat™ Hotel, which is commercially available from Thermo Fisher Scientific Inc. In the illustrative embodiment, the robotic arm 30 is a PreciseFlex PF400 SCARA™ robot four-axis articulated sample handler or similar device. In other embodiments, the robotic arm 30 may have a different number of degrees of freedom than those described herein.

As shown in FIGS. 1 and 2, the hotel 28 is positioned on a frame 32 located adjacent to the seed cutting station 16. As described in greater detail below, the cutting device 18 of the station 16 is operable to remove a sample 12 from a seed 14 when an activation switch 34 is closed. A sample guide mechanism 26 of the cutting station 16 directs the sample 12 to a sample tube of the sample tray 22. Following the cutting operation, the user may deposit the corresponding cut seed in a storage cavity or well defined in the seed tray 24 indexed to the sample tube of the sample tray 22. In the illustrative embodiment, the cutting station 16 includes a seed sensor 38 that is operable to detect when a cut seed has been deposited in the seed tray 24. When the trays 22, 24 are filled with samples and cut seeds, the robotic arm 30 moves the trays 22, 24 from the seed cutting station 16 to the hotel 28. The hotel 28 stores the trays 22, 24 such that they are indexed by location.

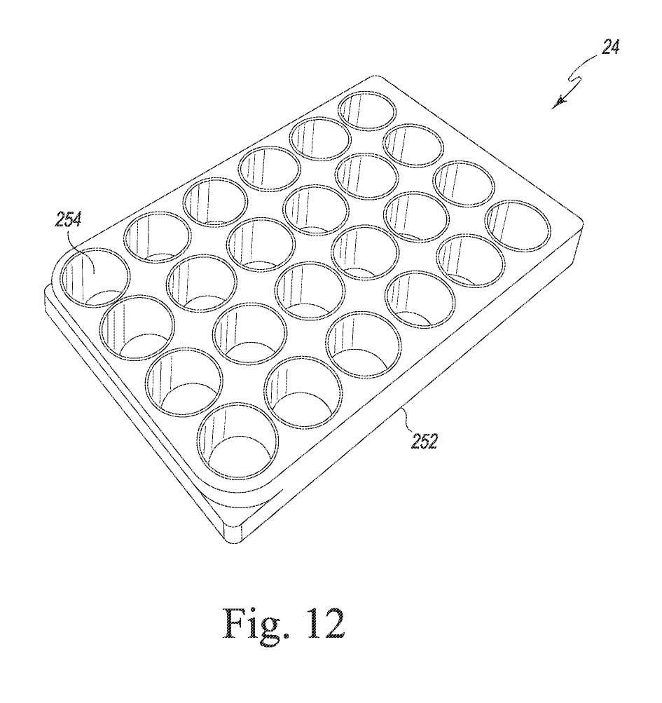

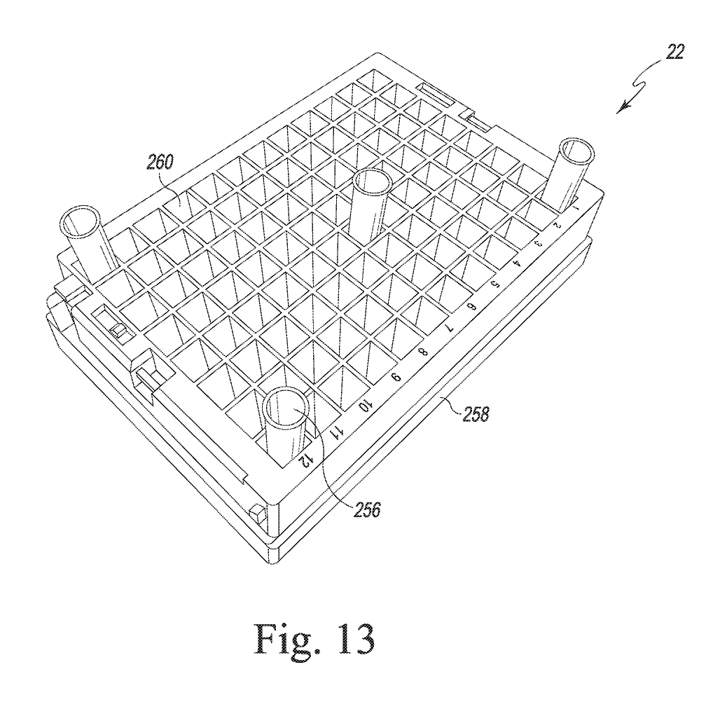

For example, the trays 22, 24 and the wells of the trays 22, 24 may be indexed such that the user is able to identify which sample tray 22 holds samples taken from the seeds of any of the seed trays 24. The wells of the trays 22, 24 may be indexed such that the user is able to identify the sample 12 taken from any seed 14. The sample tray 22 and the seed tray 24 are described in greater detail below in reference to FIGS. 12-13. It should be appreciated that in other embodiments the system 10 may include multiple hotels 28, with each sample 12 mapped to its corresponding seed 14 and vice versa.

As shown in FIG. 2, the system 10 also includes a cleaning system 40 that is operable to clean the sample guide mechanism 26 between uses. In the illustrative embodiment, the cutting device 18, the sample guide device 36, the cleaning system 40, and the other electrically-operated components of the system 10 are controlled by an electronic controller 50. The controller 50 is, in essence, the master computer responsible for interpreting electrical signals sent by sensors, i.e., seed sensor 38, associated with the system 10 and for activating or energizing electronically-controlled components associated with the system 10.

While the electronic controller 50 is shown as a single unit in FIG. 2, the controller 50 may include a number of individual controllers for the various components as well as a central computer that sends and receives signals from the various individual controllers. The electronic controller 50 also determines when various operations of the system should be performed. As will be described in more details below, the electronic controller 50 is operable to control the components of the system such that the system removes the sample 12 from the seed 14 without contamination and indexes the sample 12 and the seed 14 from which the sample 12 is taken.

To do so, the electronic controller 50 includes a number of electronic components commonly associated with electronic units utilized in the control of electromechanical systems. For example, the electronic controller 50 may include, amongst other components customarily included in such devices, a processor such as a microprocessor 52 and a memory device 54 such as a programmable read-only memory device (“PROM”) including erasable PROM's (EPROM's or EEPROM's). The memory device 54 is provided to store, amongst other things, instructions in the form of, for example, a software routine (or routines) which, when executed by the microprocessor 52, allows the electronic controller 50 to control operation of the system 10.

The electronic controller 50 also includes an analog interface circuit 56 (BBD201 commercially available from THORLABS). The analog interface circuit 56 converts the output signals from the various components into signals that are suitable for presentation to an input of the microprocessor 52. In particular, the analog interface circuit 56, by use of an analog-to-digital (A/D) converter (not shown) or the like, converts the analog signals generated by the sensors into digital signals for use by the microprocessor 52. It should be appreciated that the A/D converted may be embodied as a discrete device or a number of devices, or may be integrated into the microprocessor 52. It should also be appreciated that if any one or more of the sensors associated with the system 10 generate a digital output signal, the analog interface circuit 56 may be bypassed.

Similarly, the analog interface circuit 56 converts signals from the microprocessor 52 into output signals which are suitable for presentation to the electrically-controlled components associated with the system (e.g., the cutting device 18). In particular, the analog interface circuit 56, by use of a digital-to-analog (D/A) converter (not shown) or the like, converts the digital signals generated by the microprocessor 52 into analog signals for use by the electronically-controlled components associated with the system 10. It should be appreciated that, similar to the A/D converter described above, the D/A converter may be embodied as a discrete device or number of devices, or may be integrated into the microprocessor 52. It should also be appreciated that if any one or more of the electronically-controlled components associated with the system 10 operate on a digital input signal, the analog interface circuit 56 may be bypassed.

Further, the controller 50 may provide setup instructions to the user on a display 58 (e.g., to provide the seed to the cutting device), retrieve input from the user via a user input device 60 (e.g., the species of seed to be cut, the type of trays 22, 24 being used, the type of hotel 28 being used, etc.). The user input device 60 may be embodied as any integrated or peripheral device such as a keyboard, mouse, touchscreen, and/or other input devices configured to perform the functions described herein.

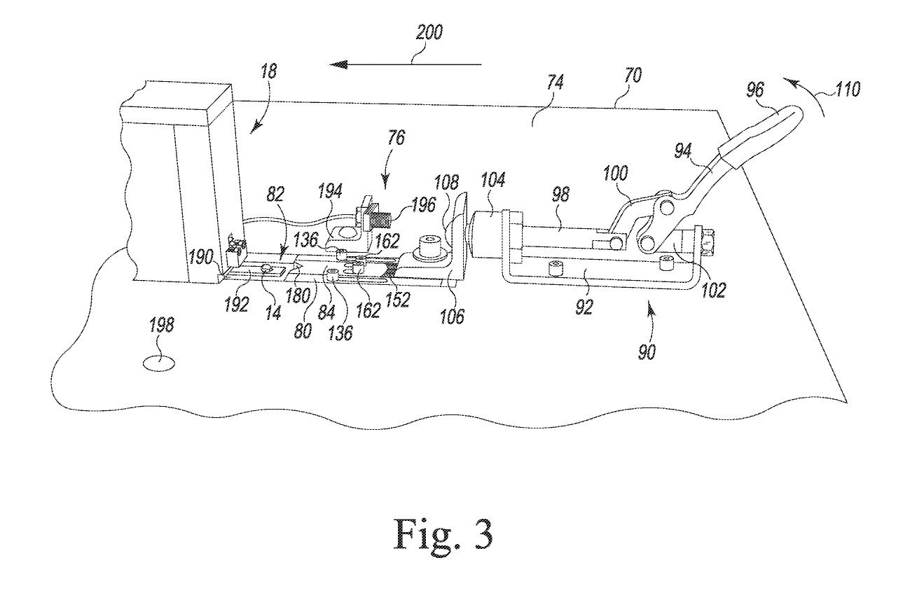

As shown in FIG. 1, the system 10 includes a tabletop 70 supported by a number of legs 72. The table 70 includes a substantially planar top surface 74 on which a seed holder assembly 76 is located. Referring now to FIG. 3, the seed holder assembly 76 includes a sled 80 that is positioned in a slot 82 defined in the top surface 74 of the tabletop 70. The sled 80 supports a seed carrier 84, and the sled 80 and seed carrier 84 are movably coupled to the tabletop 70 such that a seed may be advanced toward and away from the seed cutting device 18, as described in greater detail below.

The sled 80 of the seed holder assembly 76 is coupled to a lever assembly 90 operable to move the sled 80 (and hence the seed carrier 84) relative to the tabletop 70. The lever assembly 90 secured to the top surface 74 of the tabletop 70 via a bracket 92. In the illustrative embodiment, the lever assembly 90 includes a lever handle 94 surrounded by a soft cap 96 on one end such that the lever handle 94 may be comfortably gripped by the user. Opposite the soft cap 96, the lever handle 94 is connected to a driving rod 98 by a connecting link 100. The lever handle 94 is also connected to the bracket 92 by a shaft 102. Connecting link 100 is pivotally coupled to the driving rod 98 and the lever handle 94 at each end such that the lever handle 94, the connecting link 100, and the driving rod 98 are permitted to pivot relative to each other. The lever assembly 90 also includes a guide cylinder 104 that receives the driving rod 98 and guides the movement of the driving rod 98 along a linear path. The driving rod 98 is attached to a bracket 106 at its distal end 108. As shown in FIG. 3, the bracket 106 connects the driving rod 98 to the sled 80. As a result, when a user pushes the lever handle 94 in the direction indicated by arrow 110, the driving rod 98 and the sled 80 are advanced toward the cutting device 18.

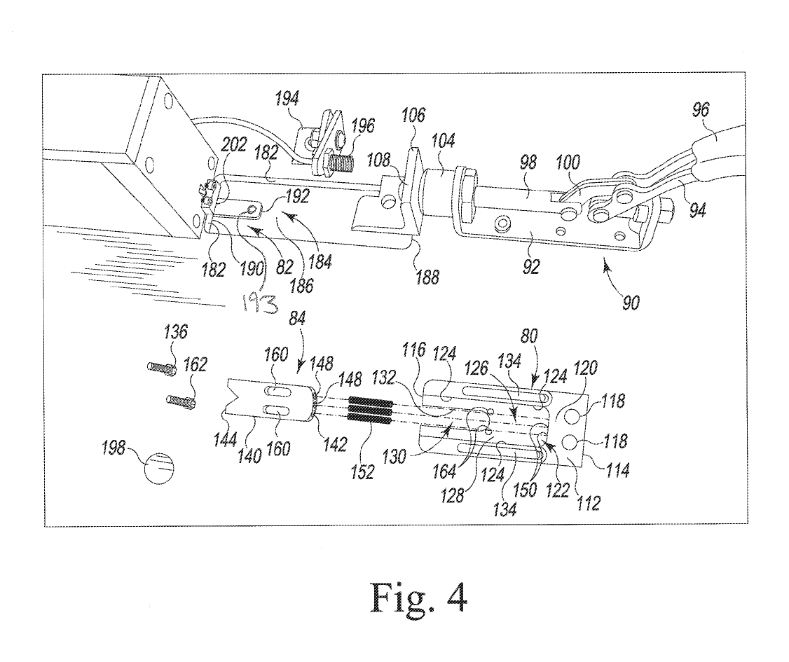

Referring now to FIG. 4, sled 80 includes an elongated body 112 that extends from an end 114 to an opposite end 116. The end 114 includes a number of threaded holes 118 sized to receive fasteners (not shown) to connect the bracket 106 to the sled 80. The elongated body 112 also includes a substantially planar upper surface 120 is positioned opposite a substantially planar bottom surface (not shown). In the illustrative embodiment, the sled 80 includes a central slot 122 that is sized to receive the seed carrier 84. As shown in FIG. 4, the central slot 122 is defined by a number of inner walls 124 that extend inwardly from an opening 126 defined in the upper surface 120 to a base surface 128. The body 112 also includes an opening 130 defined in its end 116, which opens into the slot 122. The elongated body 112 also includes a lower slot 132 that extends inwardly from the end 116 and is defined in the base surface 128.

As shown in FIG. 4, the elongated body 112 also includes a pair of elongated slots 134 positioned on each side of the central slot 122. Each slot 134 extends through the upper surface 120 and the bottom surface of the body 112 and is sized to receive a fastener, such as, for example, a bolt 136 to secure the sled 80 to the tabletop 70. The shape and size of the elongated slots 134 permit the sled 80 slide relative to the tabletop 70. It should be appreciated that in other embodiments the elongated slots may have a different configuration to permit the sled (and hence the seed carrier) to slide as required to advance the seed toward and away from the cutting device.

As described above, the seed holder assembly 76 also includes a seed carrier 84 that is coupled to the sled 80. As shown in FIG. 4, the seed carrier 84 includes an elongated body 140 that extends from an end 142 to an opposite end 144. In the illustrative embodiment, the elongated body 112 of the sled 80 and the elongated body 140 of the carrier 84 are formed from metallic materials such as, for example, stainless steel. It should be appreciated that in other embodiments the bodies 112, 140 may be formed from other materials such as, for example, a hard plastic or other polymer.

When the seed carrier 84 is positioned in the central slot 122 of the sled 80, the end 142 of the body 140 faces an inner wall 146 of the sled 80. In the illustrative embodiment, the end 142 of the carrier's body 140 has a plurality of bores 148 defined therein. The inner wall 146 of the sled 80 includes a plurality of corresponding bores 150. A number of biasing elements, such as, for example, springs 152 are sized to be received in the bores 148, 150 when the seed holder assembly 76 is assembled. As described in greater detail below, the springs 152 provide compliance during the seed cutting operation.

As shown in FIG. 4, the elongated body 140 of the carrier 84 includes a pair of elongated slots 160 that extend through upper and lower surfaces 176, 178 of the body 140. Each slot 160 is sized to receive a fastener, such as, for example, a bolt 162, which removeably couples the carrier 84 to the sled 80. Each bolt 162 is received in a corresponding threaded hole 164 defined in the base surface 128 of the sled 80. The shape and size of the elongated slots 160 permit the carrier 84 slide relative to the sled 80. It should be appreciated that in other embodiments the elongated slots may have a different configuration to permit the carrier to slide relative to the sled.

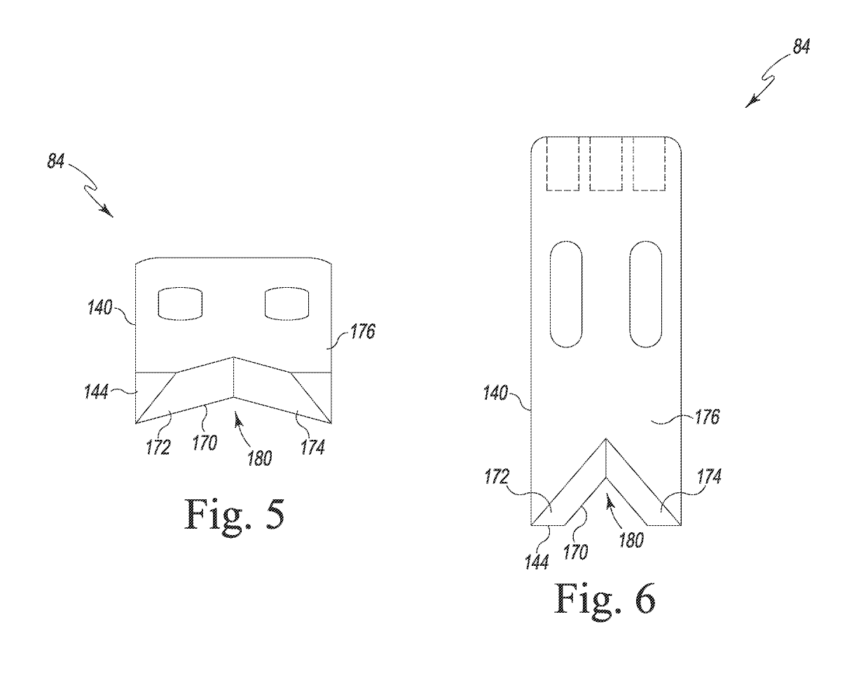

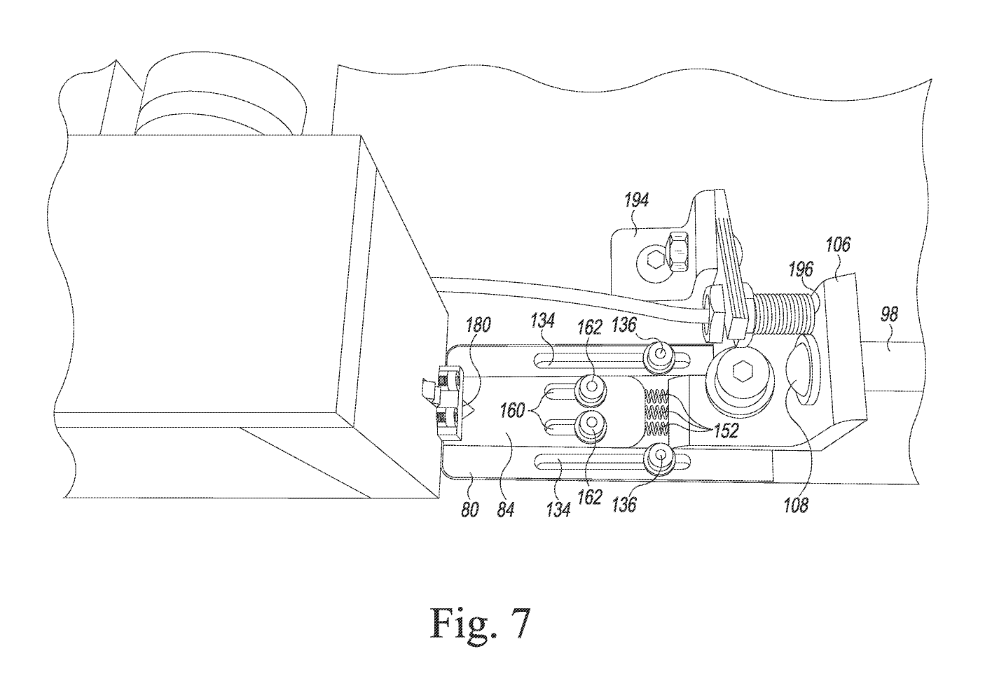

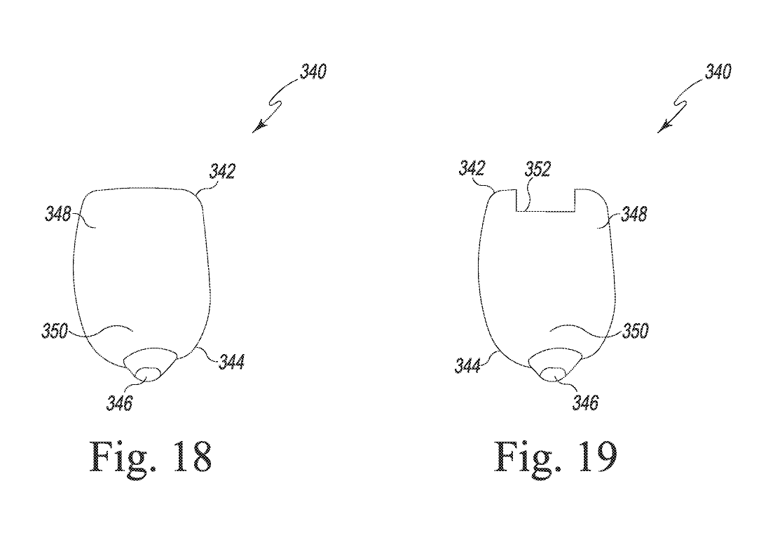

Referring now to FIGS. 5-6, the elongated body 140 of the seed carrier 84 includes a wedge 170 that is positioned at the end 144. In the illustrative embodiment, the wedge 170 is sized to receive a seed 14 and has a shape that is commentary to that of a corn seed (see FIGS. 18-19). The wedge 170 includes a pair of angled surfaces 172, 174 that extend upwardly from a lower surface 176 of the elongated body 140 to an upper surface 178. The pair of angled surfaces 172, 174 cooperate to define a V-shaped groove 180 in the end 144 of the carrier's body 140. The angled surfaces 172, 174 are disposed at an acute angle of less than about 90°. In some embodiments, the angle is from about 1° to about 89°, from about 1° to about 45°, or from about 45° to about 89°. Illustratively, the angled surfaces 172, 174 may cooperate to define other shapes for receiving a seed 14, such as a U-shaped groove.

Returning to FIG. 4, as described above, the tabletop 70 includes a slot 82 that is defined in the top surface 74 and is sized to receive the sled 80 and the seed carrier 84. In the illustrative embodiment, the slot 82 is defined by a number of inner walls 182 that extend inwardly from a rectangular opening 184 defined in the top surface 74 to a bottom surface 186. The slot 82 extends from a rear end 188 that is spaced apart from the cutting device 18 to a forward end 190 that is positioned adjacent to the cutting device 18. In some embodiments, the distance between the rear end 188 and the forward end 190 is about 45 mm.

At the forward end 190, a pedestal 192 extends upwardly from the bottom surface 186 in the middle of the slot 82. As described above, the sled's elongated body 112 includes a lower slot 132, which is sized to receive the pedestal 192. As described in greater detail below, the pedestal 192 is configured to support the seed 14 during the cutting operation.

As described above, the system 10 also includes an activation switch 34 that is operable to send an electronic signal to the controller 52 activate the cutting device 18. As shown in FIG. 4, the switch 34 is mounted in a support 194 that extends upwardly from the tabletop 70. The switch 34 is electrically connected to the controller 52 and includes a distal end 196 that faces the lever assembly 90. In the illustrative embodiment, the switch 34 is operable to detect when an object (in this case, the connecting bracket 106) contacts its distal end 196. It should be appreciated that in other embodiments the switch 34 may take the form of a magnetic sensor, Hall-effect array, or other detection mechanism.

As shown in FIG. 4, a passageway 198 is defined in the tabletop surface 74 adjacent to the slot 82. The passageway 198 is sized to receive the cut seed 14 after the cutting operation is complete, and the seed tray 24 is positioned below the passageway 198, as described in greater detail below. As indicated above, the system 10 includes a seed sensor 38 that is operable to detect when a seed is deposited in the seed tray 24. In the illustrative embodiment, the seed sensor 38 is an optical sensor that detects when a seed falls through the passageway 198. The sensor 38 is electrically connected to the controller 50 and generates an electrical signal when it detects a seed in the passageway 198. It should be appreciated that in other embodiments other sensor types may be used to detect when a seed is deposited in the tray 24.

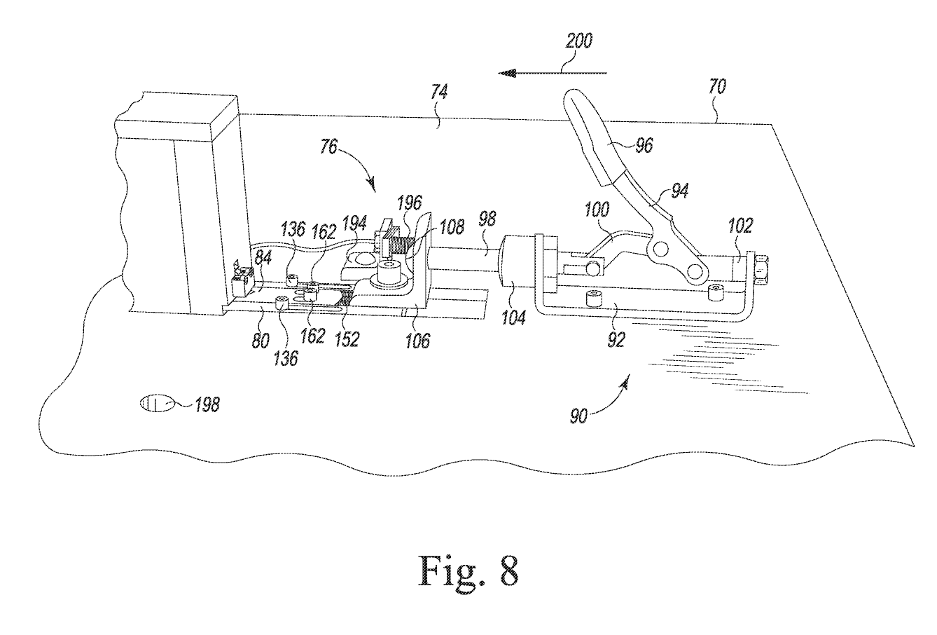

In use, a user positions a seed 14 on the pedestal 192 in the V-shaped groove 180 of the seed carrier 84 when the lever assembly 90 is in the disengaged position shown in FIG. 3. In the illustrative embodiment, the seed 14 is oriented with its tip facing away from the cutting device 18. With the seed 14 properly oriented in the seed carrier 84, a user may grasp the lever handle 94 and rotate the handle in the direction indicated by the arrow 110. As the handle 94 is rotated, the connecting link 100 causes the driving rod 98 to advance along the guide cylinder 104 in the direction indicated by arrow 200 in FIGS. 3 and 8, thereby advancing the seed holder assembly 76 and hence the seed 14 toward the cutting device 18. As the seed 14 moves toward the cutting device 18, the seed 14 slides along the pedestal 192.

When the bracket 106 engages the distal end 196 of the switch 34 as shown in FIG. 8, the electronic controller 50 activates the cutting device 18 to remove a sample from the seed 14. After the sample is removed, the electronic controller 50 deactivates the cutting device 18. In the illustrative embodiment, the sample takes the form of particles, which fall through a passageway 202 defined near the forward end 190 of the slot 82. The sample guide mechanism 26, which is positioned below the passageway 202, guides the particles into the appropriate sample tube in the sample tray 22.

The user may then rotate the handle 94 in the opposite direction to move the seed holder assembly 76 away from the cutting device 18. The user may then grasp the cut seed 14 and remove the seed from the pedestal 192. The seed 14 may then be deposited into the seed tray 24 through the passageway 198. When the electronic controller 50 detects the seed 14 following through the passageway 198, it operates the electrically controlled components of the system 10 to prepare the system 10 to take another sample, as described in greater detail below.

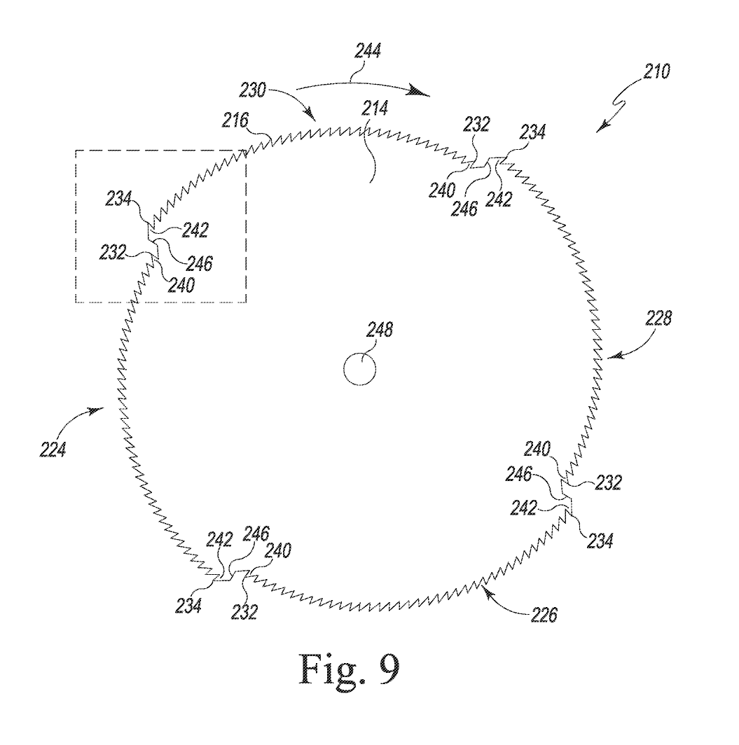

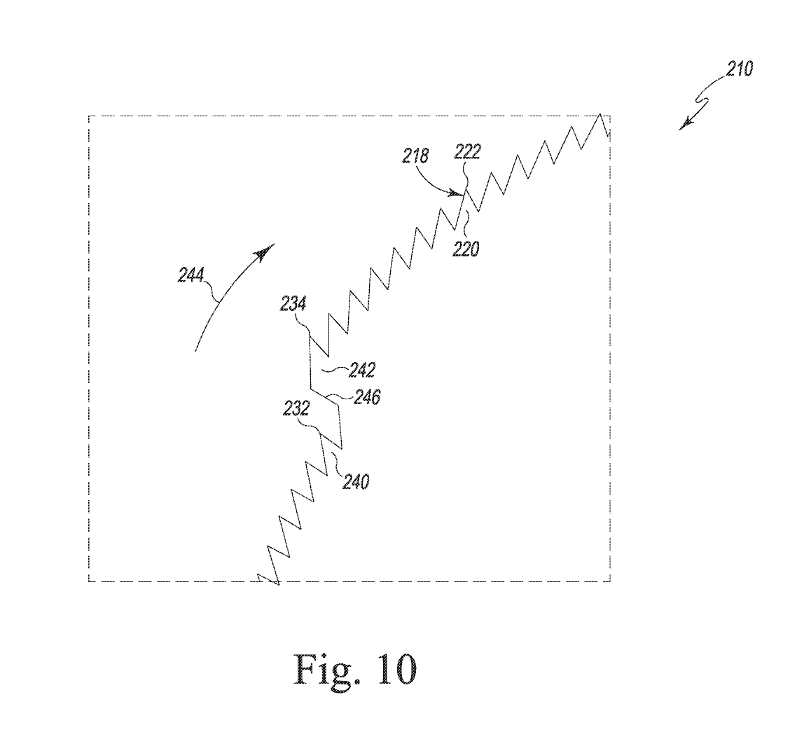

In the illustrative embodiment, the cutting device 18 of the station 16 includes a cutting blade 210, which is shown in FIGS. 9-10. The cutting blade 210 is configured to rotate about a central axis 212. As shown in FIG. 9, the blade 210 includes a narrow body 214 that is illustratively formed from a metallic material such as, for example, stainless steel. The body 214 has an outer radial edge 216, which is serrated around the entire circumference of the body 214. In other embodiments, the edge 216 may be only partially serrated.

A plurality of cutting teeth 218 are defined along the radial edge 216, and each tooth 218 extends radially outward from a base 220 to a pointed tip 222. As shown in FIG. 9, the cutting teeth 218 are grouped in a plurality of sections 224, 226, 228, and 230. In the illustrative embodiment, the configuration of each of the sections 224, 226, 228, and 230 is identical and described in greater detail below in reference to the section 224. It should be appreciated that in other embodiments the configurations of the sections may vary. It should also be appreciated that in some embodiments the cutting blade 210 may include fewer sections and, in some cases, only a single section that extends around the entire circumference of the body 214.

As shown in FIG. 9, the serrated section 224 extends from a circumferential end 232 to another circumferential end 234. The tips 222 of the cutting teeth 218 in the section 224 defined a radius that increases gradually from the end 232 to the end 234. For example, the tip 222 of the end-most cutting tooth 240 at the end 232 defines a radius R₁. The tip 222 of the end-most cutting tooth 242 at the opposite end 234 defines a radius R₂ that is greater than the radius R₁. In the illustrative embodiment, the radius R₁ is equal to about 69.9 mm or 70 mm, and the radius R₂ is equal to about 75.9 mm or 76 mm.

As shown in FIG. 10, the teeth 218 in the serrated section 224 extend radially outward and away from the end 234 of the section 224. In that way, the tips 222 of the cutting teeth 218 extend in the direction of rotation as indicated by the arrow 244 in FIGS. 9-10. In some embodiments, a large number of equally spaced teeth 218 are employed to produce finer cuts. Conversely, in some embodiments, a smaller number of equally spaced teeth 218 are employed to produce coarser cuts. In some embodiments, the apparatus provided have teeth per inch between 5 and 15; between 7.25 and 11.5; between 5.5 and 9.25; or between 9.5 and 14.25. Additionally, the size and pitch of the teeth 218 may be configured to optimally remove a sample 12 from any given species of seed 14. In some embodiments, the size of pitch provided is between 2.2 mm and 3 mm; or between 2.5 mm and 3.5 mm. The serrated sections 224, 226, 228, and 230 are connected by a radially extending segment 246 that is positioned adjacent to the end-most teeth 240, 242 of adjacent sections.

The cutting device 18 also includes an electric motor (not shown) that is operated by the controller 50 to rotate the cutting blade 210 in the direction indicated by arrow 244 to selectively cut the seeds 14. The body 214 of the cutting blade 210 includes a mounting bore 248 that is sized to be positioned on the output shaft of the electric motor. In other embodiments, the cutting device 18 may include a clean device such as, for example, a brush or positive pressure source, to clean the serrated edge 216 between cutting operations.

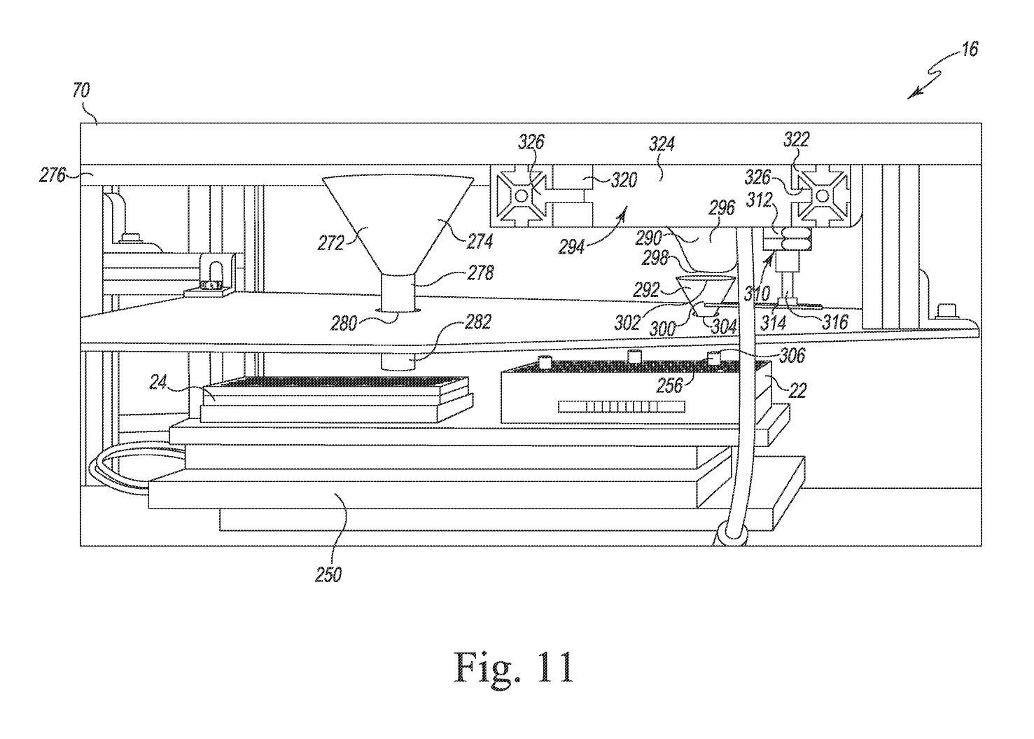

Referring now to FIG. 11, the underside of the seed cutting station 16 is shown in greater detail. As described above, the seed cutting station 16 includes a sample tray 22 and a seed tray 24 that are positioned below the cutting device 18 and the seed passageway 198, respectively. The trays 22, 24 are positioned on a motorized platform 250 of the indexing system 20. In the illustrative embodiment, the motorized platform 250 is operable to move in two directions (e.g., x and y) to reposition the trays 22, 24 relative to the cutting device 18 and the seed passageway 198. One example of a platform 250 is the MLS203, which is commercially available from THORLABS. The motorized platform 250 is connected electrically to the controller 50, which operates the motorized platform 250 after a sample has been taken and a seed 14 deposited in the tray 24.

Referring now to FIG. 12, an exemplary seed tray 24 is shown. The tray 24 includes a rectangular body 252 and a plurality of cavities or wells 254 that are defined in the body 252. Each well 254 is sized to receive one of the cut seeds 14. In the illustrative embodiment, the tray 24 is formed from an acrylic material. It should be appreciated that in other embodiments the tray 24 may be formed from other plastic materials.

Referring now to FIG. 13, an exemplary sample tray 22 is shown with a number of sample tubes 256. The tray 22 includes a rectangular body 258 and a plurality of tube chambers 260 that are defined in the body 258. Each tube chamber 260 is sized to receive a single sample tube 256. When the trays 22, 24 are positioned on the platform 250, the location of each chamber 260 (and hence each sample tube 256) of the sample tray 22 is indexed to the location of each well 254 of the seed tray 24. As a result, a sample deposited in one of the sample tubes 256 is indexed or tied to the seed 14 that is deposited in the corresponding well 254 of the seed tray 24, thereby permitting the user to track the sample and the seed 14 during subsequent processing.

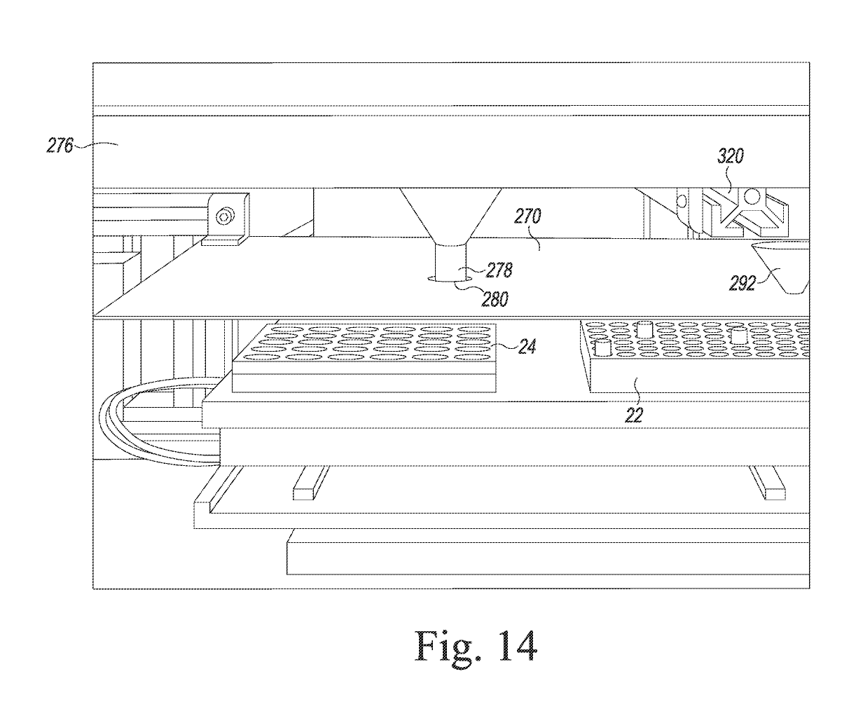

Returning to FIG. 11, the trays 22, 24 are positioned below a protective barrier 270 that separates the trays 22, 24 from the cutting device 18. As described above, a user deposits a cut seed 14 in a seed passageway 198 defined in the tabletop 70 upon the completion of the cutting operation. In the illustrative embodiment, a funnel 272 is positioned below the passageway 198 to guide the cut seed 14 into a particular well 254 of the seed tray 24. The funnel 272 includes a conical upper section 274 that is secured to the bottom surface 276 of the tabletop 70 and a cylindrical lower section 278 that extends downwardly from the upper section 274. As shown in FIG. 14, the cylindrical lower section 278 extends through an opening 280 defined in the protective barrier 270 and has a lower end 282 positioned above the sample tray 24.

As described above, the system 10 also includes a sample guide mechanism 26 that guides the sample 12 (i.e. the particles of the seed) into a sample tube 256 of the sample tray 22. As shown in FIG. 11, the sample guide mechanism 26 includes an upper funnel 290 and a lower funnel 292 that is configured to move relative to the upper funnel 290. In the illustrative embodiment, the upper funnel 290 is secured to a drive frame 294 that is configured to move the funnels 290, 292 into and out of position below the cutting device 18.

The upper funnel 290 includes a conical body 296 that has an upper opening (not shown) that is configured to be positioned directly below the sample passageway 202. The conical body 296 includes a lower opening 298 that faces the lower funnel 292. The lower funnel 292 also includes a conical body 300 that has an upper opening 302 positioned below the lower opening 298 of the upper funnel 290. As shown in FIG. 11, the lower funnel's body 300 is sized to be received in an opening 304 defined in the protective barrier 270 such that a lower opening 306 of the body 300 is positioned above a sample tube 256.

As described above, the lower funnel 292 is configured to move relative to the upper funnel 290. In the illustrative embodiment, the sample guide mechanism 26 includes an electrically operated actuator 310 that is coupled at its upper end 312 to the upper funnel 290 and at its lower end 314 to the lower funnel 292. The actuator 310 includes a piston 316 that is configured to move in the direction indicated by arrows 318 when operated by a motor (not shown). When the motor is energized by the controller 50, the piston 316 is drawn upward, thereby causing the lower funnel 292 to withdraw from the opening 304 in the protective barrier 270 and move toward the upper funnel 290.

The sample guide mechanism 26 also includes a drive frame 294 that is operable to move the funnels 290, 292 into and out of position below the cutting device 18. In the illustrative embodiment, the frame 294 includes a pair of beams 320, 322 positioned on each side of the funnels 290, 292. The funnels 290, 292 are coupled to a crossbeam 324 extending between the beams 320, 322. Each end (not shown) of the crossbeam 324 is received in a longitudinal slot 326 defined in each beam 320, 322. The crossbeam 324 is configured to slide along the slots 326 of the beams 320, 322 between a sampling position in which the funnels 290, 292 are positioned below the sample passageway 202 and a cleaning position in which the funnels 290, 292 are spaced apart from the sample passageway 202. The sample guide mechanism 26 includes another linear actuator 330 that is operated by the controller 50 to move the crossbeam 324 between the sampling position and the cleaning position.

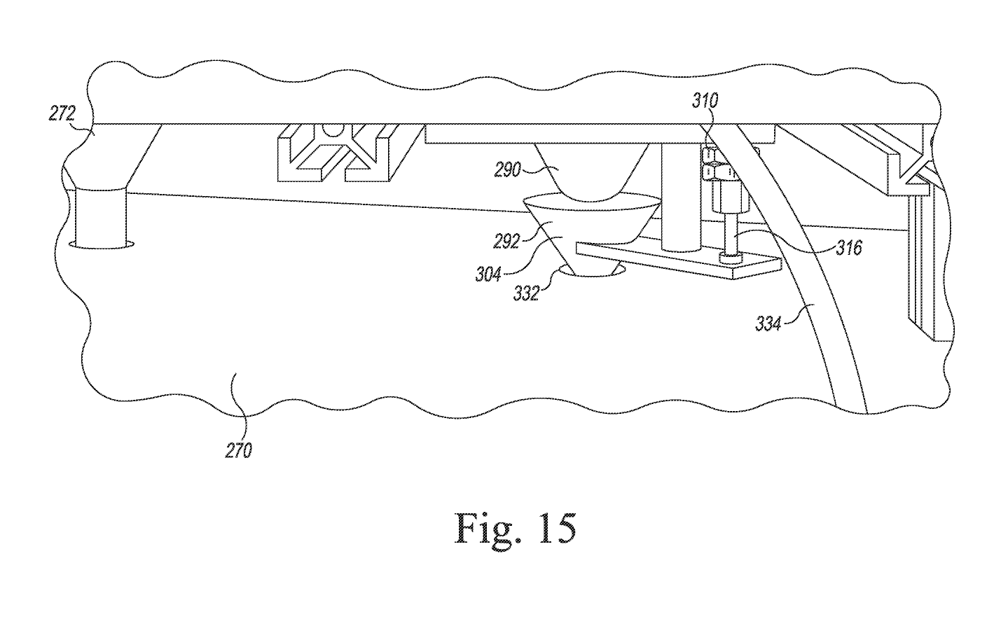

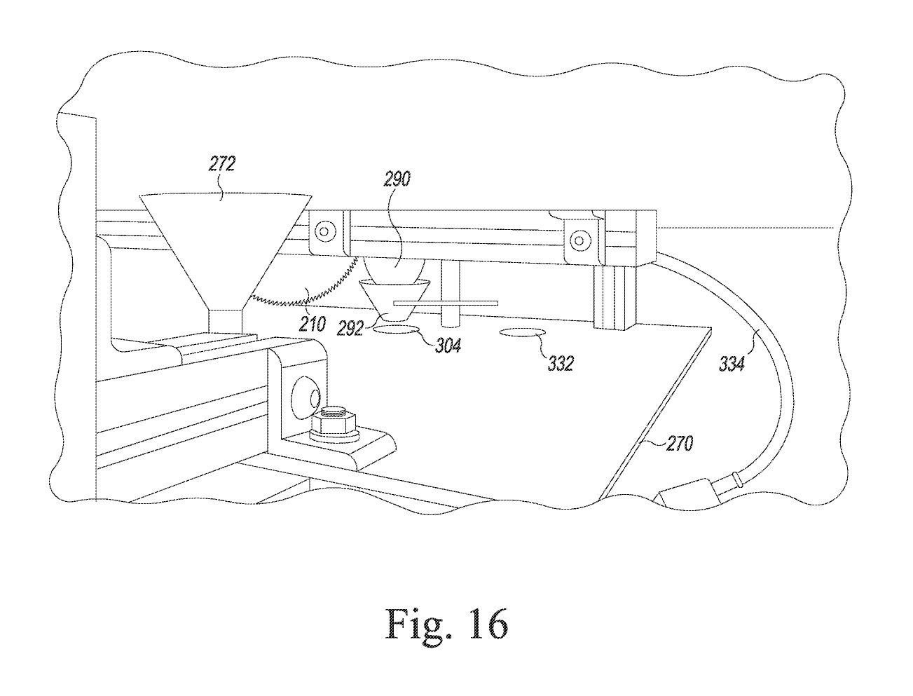

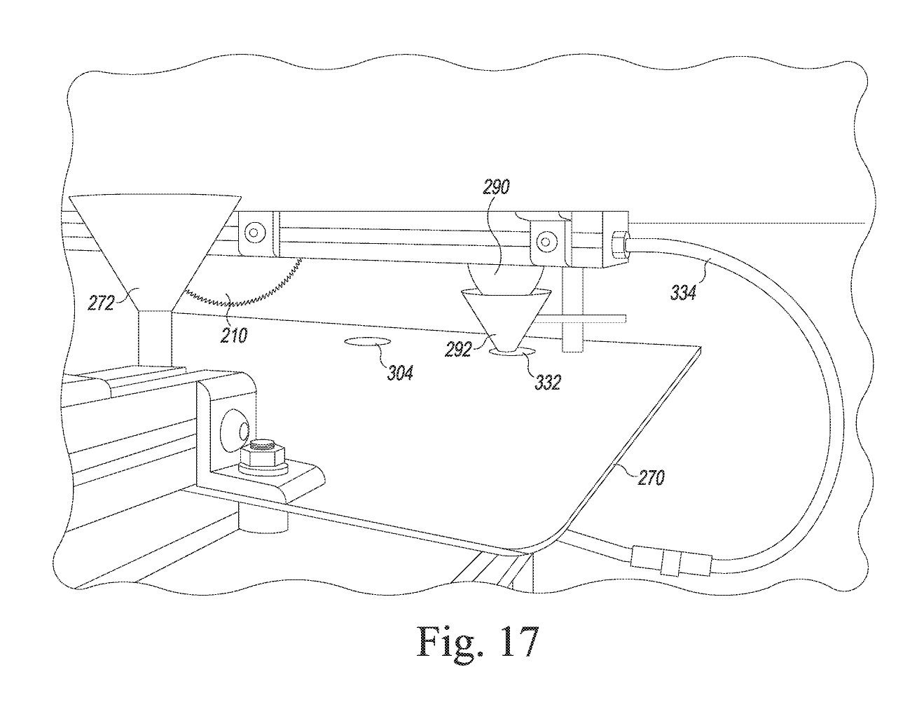

The operation of the sample guide mechanism 26 is illustrated in FIGS. 15-17. As shown in FIG. 15, the funnels 290, 292 are positioned below the sample passageway 202, with the lower funnel 292 positioned in the opening 304. When the actuator 310 is energized by the controller 50, the piston 316 is drawn upward, thereby causing the lower funnel 292 to withdraw from the opening 304 in the protective barrier 270 and move toward the upper funnel 290, as shown in FIG. 16. The controller 50 then activates the actuator 330 to move the funnels 290, 292 from the sampling position shown in FIG. 16 to the cleaning position shown in FIG. 17. In the cleaning position, the funnels 290, 292 are positioned above another opening 332 defined in the protective barrier 270.

As described above, the system 10 also includes a cleaning system 40 that is operable to clean the funnels 290, 292 between cutting operations. In the illustrative embodiment, the system 10 includes a positive pressure source 334, which is electrically connected to the controller 50. When the funnels 290, 292 are in the cleaning position shown in FIG. 17, the controller 50 activates the positive pressure source 334 to advance a cleaning fluid into the funnels 290, 292 and remove any particles in the funnels 290, 292 to prevent contamination. The positive pressure source 334 is illustratively a compressed air source and the cleaning fluid is compressed air. It should be appreciated that in other embodiments other cleaning fluids may be used to clean the funnels 290, 292. After the controller 50 has activated positive pressure source, the controller 50 activates the actuator 330 to move the funnels 290, 292 from the cleaning position back to the sampling position. The controller 50 may then deenergize the other actuator 310 to move the piston 316 downward and position the lower funnel 292 in the opening 304 of the protective barrier 270.

As described above, the system 10 may be used to cut a seed such as, for example, the corn seed 340 shown in FIGS. 18-19. The corn seed 340 has a broad end 342 and a narrow end 344 positioned opposite the broad end 342. The end 344 converges to a tip cap 346. The endosperm 348 of the corn seed 340 is substantially located near the broad end 342, and the embryo 350 is substantially located near the narrow end 344. The system 10 may be operated to remove a sample from the broad end 342, as shown in FIG. 19. The system 10 create a notch 352 in the broad end 342 corresponding in width to the cutting blade 210 and a depth corresponding to the several factors, including, for example, the radius R₂ of the cutting blade 210 and the position of the seed 14 in the holder assembly 76. The radius of the cutting blade 210, the number of teeth 218, the position of the teeth 218, the rotation speed of the cutting blade 210, and the pressure applied to the seed 340 are designed such that a granule sample is removed from the seed 14 without destroying the viability of the seed 14 (i.e., damaging the seed embryo or cracking the seed).

To use the system 10 to take a sample 12 from a seed 340, a user positions the seed on the pedestal 192 defined in the tabletop 70 within the V-shaped groove 180 of the seed carrier 84. As described above, the seed 340 is oriented with its broad end 342 facing the cutting device 18 and its tip cap 346 engaged with the angled surfaces 172, 174 of the carrier 84. When the seed 340 is properly oriented in the seed carrier 84, a user may grasp the lever handle 94 and rotate the handle in the direction indicated by the arrow 110 in FIG. 3. As the handle 94 is rotated, the connecting link 100 causes the driving rod 98 to advance along the guide cylinder 104 in the direction indicated by arrow 200 in FIGS. 3 and 8, thereby advancing the seed holder assembly 76 and hence the seed 340 toward the cutting device 18. As the seed 340 moves toward the cutting device 18, the seed 340 slides along the pedestal 192.

When the bracket 106 engages the distal end 196 of the switch 34 as shown in FIG. 8, the seed 340 is located at the cutting position, with its broad end 342 aligned with the cutting blade 210. In the illustrative embodiment, the broad end 342 is positioned at the circumferential end 232 of one of the sections 224, 226, 228, and 230 of the cutting blade 210. Because the switch 34 is closed when the bracket 106 engages its distal end 196, the electronic controller 50 energizes the electric motor of the cutting device 18 to rotate the cutting blade 210 approximately 90 degrees. As described above, each of the sections 224, 226, 228, and 230 of the cutting blade 210 has a radius that gradually increases from the circumferential end 232 to the circumferential end 234. When the cutting blade 210 is rotated, the cutting teeth 218 progressively engage the seed 340, with each tooth 218 cutting deeper into the broad end 342 of the seed 340.

As a result, the blade 210 initially makes little or no contact with the seed 340. As the blade 210 rotates, the blade 210 penetrates deeper into the seed gradually due to the gradual increase in radius. The pressure that the seed 340 experiences is dampened by the springs 152, which create compliance between the carrier 84 and the sled 80. For example, the springs may be sized to prevent the cutting blade 210 from applying a force capable of cracking the seed 340 while also creating sufficient pressure to hold the seed 340 in position during the cutting operation. In some embodiments, the springs 152 are about 12.5 mm in length. It should be appreciated that the springs and the increase radii, among other things, may be adjusted depending on the species of seed being cut.

As the blade 210 cuts the seed 340, sample particles 12 are created and directed down the sample passageway 202. The sample particles 12 pass out of the passageway 202 and into the upper funnel 290. The conical shape of the upper funnel 290 directs the sample particles 12 out through the lower opening 298 of the funnel 290 and into the lower funnel 292. The conical shape of the lower funnel 292 guides the sample particles 12 into a sample tube 256 positioned below the lower funnel 292. After the sample is removed, the electronic controller 50 deactivates the cutting device 18.

The electronic controller 50 may activate the actuator 310 to pull the lower funnel 292 away from the protective barrier 270 before activating the other actuator 330 to move the funnels 290, 292 from the sampling position to the cleaning position. With the funnels 290, 292 in the cleaning position, the electronic controller 50 activates to clean the funnels 290, 292 and remove contaminants. The controller 50 may then activate the actuators 310, 330 to move the funnels 290, 292 back to the sampling position and return the funnel 292 to its position in the protective barrier 270.

The user may then rotate the handle 94 in the opposite direction to move the seed holder assembly 76 away from the cutting device 18. The user may then remove the seed 340 from the pedestal 192 and deposit the seed 340 into the seed passageway 198. The seed 340 passes through the passageway 198, down the funnel 272 and into a well 254 of the seed tray 24. The sensor 38 detects the passage of the seed 340, and the controller 50 activates the motorized platform 250 to move the trays 22, 24 into position to receive another sample and seed.

When the sample and seed trays 22, 24 are full or when the user instructs the system 10 via the controller 50, the robotic arm 30 is activated to remove the trays from the indexing system 20. The robotic arm 30 moves the sample tray 22 to the capping station and the seed tray to the sealing station before moving both trays to the hotel. The locations of the trays in the hotel are be determined by the controller such that corresponding seed and sample trays can be located as a pair.

In some embodiments, the samples are removed from the hotel 28 for DNA extraction and genetic testing by methods known in the art. In additional embodiments, the samples are removed from the hotel 28 for protein extraction and genetic, protein expression, and post-translational protein modification testing by methods known in the art. In further embodiments, the samples are removed from the hotel 28 for fatty acid oil extraction and genetic and fatty acid expression testing by methods known in the art. Depending on the genetic properties of any of the samples, it may be desirable to plant the seed from which the sample was removed. Accordingly, the seed corresponding to any of the samples may be identified and planted. In one embodiment, stations in the hotel and wells in the trays are labeled such that the seed corresponding to the sample is readily identified. In another embodiment, the controller is used to identify the seed corresponding to the sample. For example, trays may be supplied a barcode when they are moved to the hotel that may be scanned to allow the controller to determine the location of a corresponding tray.

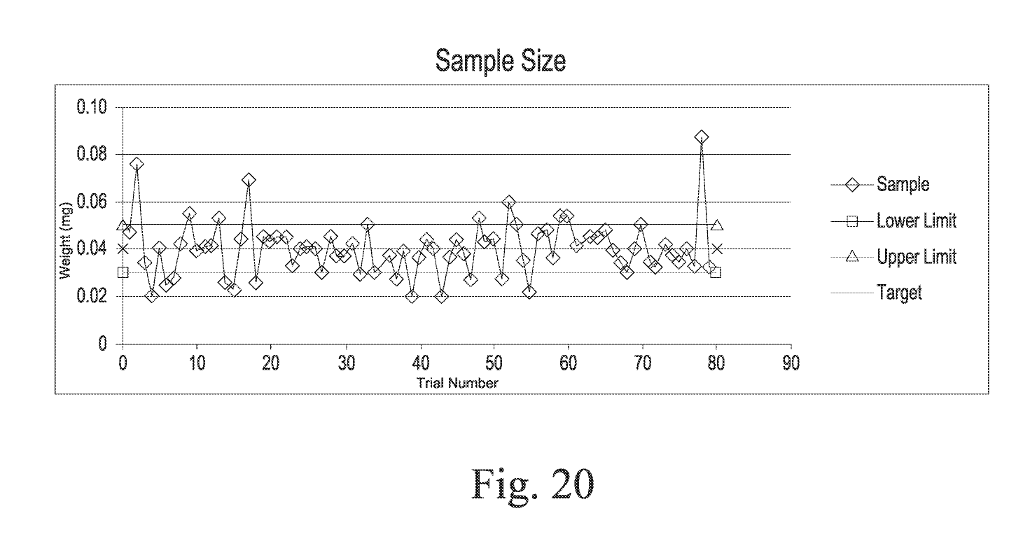

The methods and apparatus of the present disclosure provide the benefit of preparing samples that may be readily used for DNA extraction. As shown in FIG. 20, about 80 corn seeds were cut using the methods and the apparatus described herein. The figure shows the weight of the sample resulting from each trial. The resulting samples had an average size of 40.003 mg, and 68% of the samples were between 30 mg and 50 mg. The samples were adequate for genotyping, and the consistent size of the samples facilitated genotyping.

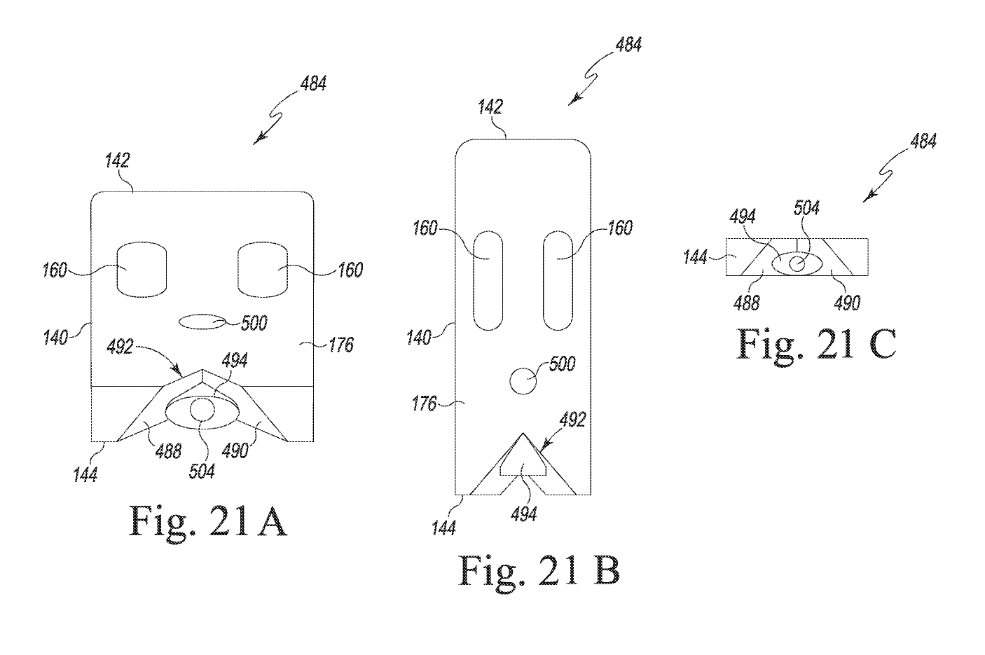

As described above, the seed carrier 84 is removably coupled to the sled 80 of the holder assembly 76. In that way, the seed carrier 84 is interchangeable with other seed carriers designed for specific seed types. For example, in FIGS. 21A-C, a seed carrier 484 for use with a seed with a round morphology, such as a soybean seed, is shown. The seed carrier 484, like the carrier 84, includes an elongated body 140 that extends from an end 142 to an opposite end 144. The end 142 of the carrier's body 140 has a plurality of bores 148 defined therein, which are sized to receive the springs 152.

The elongated body 140 of the carrier 484 includes a pair of elongated slots 160 that extend through the upper and lower surfaces 176, 178 of the body 140. Each slot 160 is sized to receive a fastener, such as, for example, the bolt 162, which removeably couples the carrier 84 to the sled 80. Each bolt 162 is received in a corresponding threaded hole 164 defined in the base surface 128 of the sled 80. The shape and size of the slots 160 permit the carrier 484 slide relative to the sled 80.

The elongated body 140 of the seed carrier 484 includes a pair of angled surfaces 488, 490 that extend upwardly from a lower surface 176 of the elongated body 140 to an upper surface 178. The pair of angled surfaces 488, 490 cooperate to define a V-shaped groove 492 in the end 144 of the carrier's body 140. The angled surfaces 488, 490 are disposed at an acute angle of less than about 90°. In some embodiments, the angle is from about 1° to about 89°, from about 1° to about 45°, or from about 45° to about 89°. Illustratively, the angled surfaces 488, 490 may cooperate to define other shapes for receiving a seed 14, such as a U-shaped groove. The body 140 also includes a wedge 494 that is positioned between the surfaces 488, 490. The wedge 494 is oval-shaped and is sized to receive a soybean seed. In the illustrative embodiment, the carrier 484 includes a circular manifold 500 that may be connected to a negative pressure source 502. The circular manifold 500 leads to an opening 504 that opens into the wedge 46, thereby providing negative pressure to hold the soybean seed in the wedge 494. Referring to FIG. 4, the pedestal 192 may include a port 193 that cooperatively interacts with the circular manifold 500 of the seed carrier 484 as the seed carrier 484 slides along the pedestal 192.

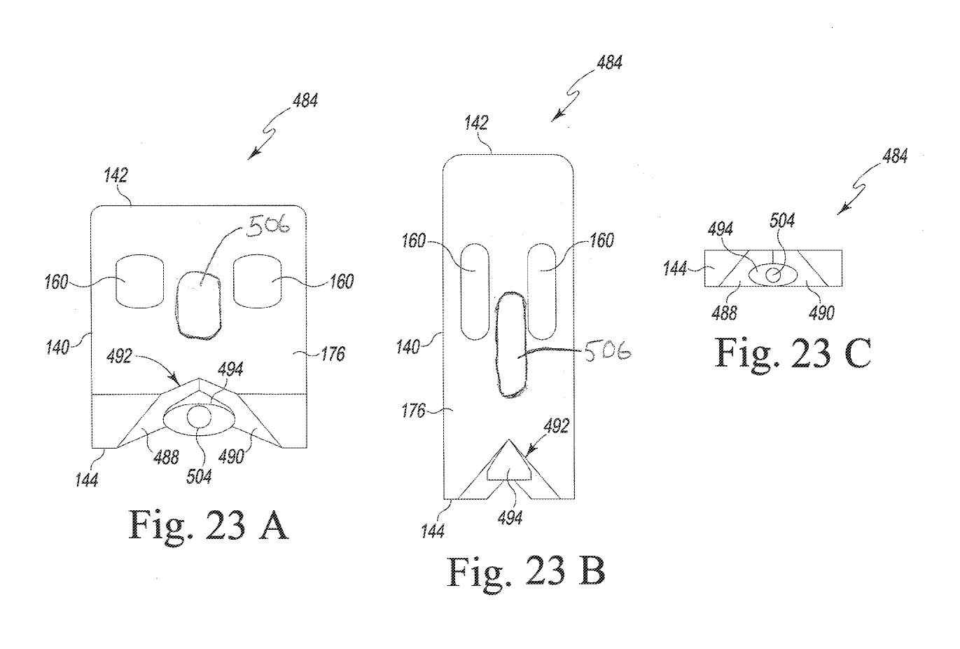

As shown in FIGS. 23A-C, in an alternative embodiment of the seed carrier 484, an elongated manifold 506 may be employed instead of the circular manifold 500. The elongated manifold 506 extends in the same direction as the elongated body 140 of the seed carrier 484. As the seed carrier 484 is pushed forward along the pedestal 192, the port 193 of the pedestal 192 comes into contact with the elongated manifold 506. When in contact, the port 193 and the elongated manifold 506 cooperatively interact to provide negative pressure to the opening 504 of the wedge 46. As the seed carrier 484 is retracted, the elongated manifold 506 ceases to cover the port 193, and negative pressure is no longer provided to the opening 504.

Illustratively, the seed carrier 484 maintains the orientation of a seed 14 having a round or spheroid type morphology, such as the morphology of a soybean. Round seeds 14 have a tendency to roll while advancing along the pedestal 192 toward the cutting blade 210. However, when negative pressure is applied to the opening 504 of the seed carrier 484, the seed 14 is held against the wedge 494, and the orientation of the seed 14 is maintained as the seed 14 slides along the pedestal 192 and while the seed 14 is contacted by the cutting blade 210. Thus, the seed carrier 484 provides the advantage of preventing round seeds 14 from rolling and reorienting such that the cutting blade 210 may compromise the viability of the seed 14.

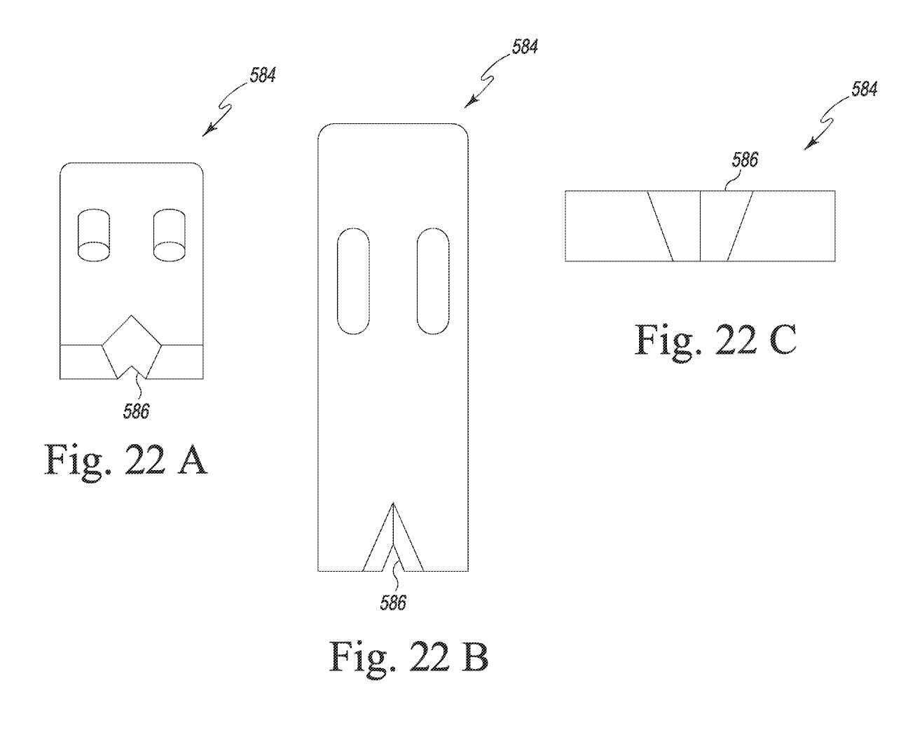

Another embodiment of a seed carrier (hereinafter seed carrier 584) is shown in FIGS. 22A-C. The seed carrier 584 includes a wedge 586 shaped to receive a cottonseed.

There are a plurality of advantages of the present disclosure arising from the various features of the method, apparatus, and system described herein. It will be noted that alternative embodiments of the method, apparatus, and system of the present disclosure may not include all of the features described yet still benefit from at least some of the advantages of such features. Those of ordinary skill in the art may readily devise their own implementations of the method, apparatus, and system that incorporate one or more of the features of the present invention and fall within the spirit and scope of the present disclosure as defined by the appended claims.

In one embodiment, blade cleaning can be improved by employing robust brushes on sides and top of the blade. In another embodiment, Teflon coating is applied to blade for reducing seed particles sticking to the blade. In another embodiment, seed debris spread can be reduced by cleaning and/or blowing-off a funnel enclosing a pre-defined discard area. In another embodiment, seed debris spread can be reduced by applying vacuum or air stream for directing seed debris to a pre-defined discard area. In another embodiment, blade depth can be modified based on seed population, weight, or size. In another embodiment, blade shape can be flattened to enable a shallower or wider cut (for example aka pill splitter).

### EXAMPLES

### Example 1

To demonstrate DNA testing using samples from both Corn and Soybean seeds, populations of Corn and Soybean seeds are collected. Lab operators manually place each seed on the seed cutter provided herein to obtain a sample. Samples are collected manually onto a 96-well plate. The remaining cut seeds are transferred manually to a separate plate. Throughput of the system used is estimated about 100-300 seeds per hour for Corn, and about 60-180 seeds per hour for Soybean.

DNA extraction protocols are developed separately for Corn and Soybean to enable extraction of high-quality DNA from the cut samples. The extracted DNA is then manually transferred for different analysis including Kaspar markers, High-Density Infinium markers, and/or Sequencing where these analyses are well known in the art.

The remaining cut seeds are planted in green houses along with uncut seed controls. Germination rates for the cut seeds are observed and compared to uncut seeds. After germination, leaf samples are taken from the seedlings for DNA extraction. The extracted leaf DNA is then transferred for different analysis including Kaspar markers, High-Density Infinium markers, and/or Sequencing to be compared with extracted seed DNA.

Table 1 shows representative results of Corn seed and leaf DNA comparison using Kaspar, and Table 2 shows representative results of Corn seed and leaf DNA comparison using Infinium. Both results show that data from Corn seed DNA are consistent with data from Corn leaf DNA.

TABLE 1
Representative results of Corn seed and leaf DNA comparison using Kaspar

| Corn population | # of samples compared | Allele call match % using Kaspar |
|---|---|---|
| A1 | 42 | 98.8 |
| A2 | 43 | 98.8 |
| A3 | 42 | 90.6 |
| A4 | 40 | 98.3 |

TABLE 2
Representative results of Corn seed and leaf DNA comparison using Infinium

| Corn population | # of samples compared | Allele call match % using Infinium |
|---|---|---|
| B1 | 23 | 99.5 |
| B2 | 45 | 99.6 |
| B3 | 43 | 97.4 |
| B4 | 42 | 98.9 |

In addition, Table 3 shows representative results of Corn seed DNA comparison of single-nucleotide polymorphism (SNPs) between Kasper and Infinium, and Table 4 shows representative results of Corn seed DNA comparison of single-nucleotide polymorphism (SNPs) between Infinium and sequencing. Both results show that good quality SNP information can be obtained using different analysis.

TABLE 3
Representative results of Corn seed DNA comparison
of single-nucleotide polymorphism (SNPs)

| | # of | # of SNPs in common | |
|---|---|---|---|
| Corn | samples | between Kasper | Allele call |
| population | compared | and Infinium | match % |
| C1 | 90 | 24 | 98.5 |
| C2 | 90 | 22 | 99.4 |

TABLE 4
Representative results of Corn seed DNA comparison
of single-nucleotide polymorphism (SNPs)

| | # of | # of SNPs in common | |
|---|---|---|---|
| Corn | samples | between Kasper | Allele call |
| population | compared | and Infinium | match % |
| D1 | 86 | 485 | 78 |
| D2 | 90 | 487 | 77.3 |

Table 5 shows representative results of Soybean seed and leaf DNA comparison using Kaspar, demonstrating data from Soybean seed DNA are consistent with data from Soybean leaf DNA

TABLE 5
Representative results of Soybean seed and
leaf DNA comparison using Kaspar

| Soybean | # of samples | # of | Allele call |
|---|---|---|---|
| population | compared | SNPs | match % |
| a1 | 62 | 17 | 89 |
| a2 | 48 | 10 | 84.3 |

In addition, Table 6 shows representative results of Soybean seed DNA comparison of single-nucleotide polymorphism (SNPs) between Kasper and Infinium, Table 7 shows representative results of Soybean leaf DNA comparison of single-nucleotide polymorphism (SNPs) between Kasper and Infinium, and Table 8 shows representative results of Soybean seed DNA comparison of single-nucleotide polymorphism (SNPs) between Infinium and sequencing. All results show that good quality SNP information can be obtained using different analysis.

TABLE 6
Representative results of Soybean seed DNA comparison of
single-nucleotide polymorphism (SNPs)

| Soybean | # of samples | # of SNPs in common | Allele call |
|---|---|---|---|
| population | compared | between Kasper and Infinium | match % |
| b1 | 89 | 14 | 99.6 |
| b2 | 90 | 16 | 98.7 |
| b3 | 90 | 14 | 99.6 |

TABLE 7
Representative results of Soybean leaf DNA comparison
of single-nucleotide polymorphism (SNPs)

| Soybean | # of samples | # of SNPs in common | Allele call |
|---|---|---|---|
| population | compared | between Kasper and Infinium | match % |
| c1 | 58 | 30 | 93.6 |
| c2 | 47 | 25 | 93.6 |

TABLE 8
Representative results of Soybean seed DNA comparison
of single-nucleotide polymorphism (SNPs)

| | | # of SNPs in common | Allele |
|---|---|---|---|
| Soybean | # of samples | between Infinium and | call match |
| population | compared | sequencing | % |
| d1 | 86 | 24 | 85.2 |
| d2 | 87 | 27 | 83.9 |
| d3 | 87 | 22 | 91.5 |

Table 9 shows representative germination study for cut Corn seed in green houses, and Table 10 shows representative germination study for cut Soybean seed in green houses. Both results show good germinate rates of cut seeds as compared to uncut seeds.

TABLE 9
Representative Corn germination study

| Corn | # of | % cut seed | % uncut seed |
|---|---|---|---|
| population | samples | germination | germination (control) |
| E1 | 100 | 97 | 100 |
| E2 | 100 | 96 | 99 |
| E3 | 100 | 93 | 98 |

TABLE 10
Representative Soybean germination study

| Soybean | # of | % cut seed | % uncut seed |
|---|---|---|---|
| population | samples | germination | germination (control) |
| e1 | 100 | 78 | 97 |
| e2 | 100 | 74 | 88 |

What is claimed is:

1. A seed cutting system/apparatus, comprising:
(a) a cutting device operable to remove material from a seed;
(b) a seed guide including an opening sized to receive material removed from the seed;
(c) a cleaning system operable to clean the seed guide; and
(d) a collection tray configured to receive material removed from the seed;
wherein the seed guide is moveable between (i) a first position in which the seed guide is positioned between the cutting device and the collection tray to direct material removed from the seed to the collection tray and (ii) a second position in which the opening of the seed guide is positioned below a nozzle of the cleaning system.

2. The seed cutting system/apparatus of claim 1, wherein the cutting device includes a body configured to rotate about a central axis, the body including a serrated section extending circumferentially from a first end to a second end, wherein the serrated section has a plurality of cutting teeth that define a first radius of the body at the first end and a second radius of the body at the second end, the second radius being greater than the first radius.

3. The seed cutting system/apparatus of claim 1, wherein the seed guide includes a funnel that is movable between the first position and the second position.

4. The seed cutting system/apparatus of claim 3, wherein the funnel includes an upper funnel and a lower funnel positioned below the upper funnel, the lower funnel being operable to be moved between a raised position and a lowered position.

5. The seed cutting system/apparatus of claim 4, further comprising a protective barrier positioned between the cutting device and the collection tray, wherein the lower funnel extends through the protective barrier when in the lowered position.

6. The seed cutting system/apparatus of claim 3, wherein the cleaning system is operable to clean the funnel when the funnel is in the second position.

7. The seed cutting system/apparatus of claim 1, wherein the cleaning system includes a compressed air source.

8. The seed cutting system/apparatus of claim 1, further comprising a second collection tray configured to receive the seed.

9. The seed cutting system/apparatus of claim 8, further comprising a sensor configured to detect when the seed is deposited in the collection tray.

10. The seed cutting system/apparatus of claim 8, further comprising an indexing system.

11. The seed cutting system/apparatus of claim 1, further comprising a linear actuator operable to move the seed guide between the first position and the second position.

12. A cutting tool comprising:
a body configured to rotate about a central axis, the body including a serrated section extending circumferentially from a first end to a second end, wherein the serrated section has a plurality of cutting teeth that define a first radius of the body at the first end and a second radius of the body at the second end, the second radius being greater than the first radius.

13. The cutting tool of claim 12, wherein the plurality of cutting teeth define a gradually increasing radius from the first end to the second end.

14. The cutting tool of claim 12, wherein:
the serrated section is a first serrated section and the plurality of cutting teeth are a first plurality of cutting teeth, and
the body includes a second serrated section that extends circumferentially from a third end adjacent to the second end of the first serrated section to a fourth end, the second serrated section having a second plurality of cutting teeth that define a third radius of the body at the third end, the third radius being less than the second radius.

15. The cutting tool of claim 14, wherein the second plurality of cutting teeth define a fourth radius of the body at the fourth end, the fourth radius being greater than the third radius.

16. A method of cutting a seed, comprising:
(a) manually placing a seed on a platform;
(b) operating a loader to move the seed along the platform toward a cutting tool;
(c) activating the cutting tool to remove a sample from the seed;
(d) removing the cut seed from the loader; and
(e) depositing the cut seed in a slot.

17. The method of claim 16, further comprising activating an indexing device to index the cut seed and the sample to associate the cut seed with the sample.

18. The method of claim 16, further comprising extracting DNA from the sample.

19. The method of claim 16, further comprising determining genetic information about the seed from the sample.

20. The method of claim 16, wherein manually placing the seed on the platform comprises orienting the seed such that an embryo of the seed faces away from the cutting tool.
